(19) United States
(12) Patent Application Publication
(10) Pub. No.: US 2026/0227483 A1
(43) Pub. Date: Aug. 6, 2026

(54) METHOD AND EARBUD CASE FOR TRACKING A USER

(71) Applicant: SAMSUNG ELECTRONICS CO., LTD., Suwon-si (KR)

(72) Inventors: Prityush CHANDRA, Bihar (IN); Abhay CHAUHAN, Uttarakhand (IN); Jhilam BERA, Howrah (IN); Pavan SUDHEENDRA, Bangalore (IN)

(73) Assignee: SAMSUNG ELECTRONICS CO., LTD., Suwon-si (KR)

(21) Appl. No.: 19/638,666

(22) Filed: Apr. 3, 2026

Related U.S. Application Data
(63) Continuation of application No. PCT/KR2024/015230, filed on Oct. 7, 2024.

(30) Foreign Application Priority Data
Oct. 6, 2023 (IN) 202341067243
Oct. 4, 2024 (IN) 202341067243

(51) Int. Cl. G01S 5/02; G01C 21/16; G10L 25/78; H04R 1/02; H04R 1/10

(52) U.S. Cl. CPC G01S 5/0284; G01C 21/16; G10L 25/78; H04R 1/028; H04R 1/1016; H04R 1/1041

(57) ABSTRACT

A method includes estimating position vectors in 3D space for one or more earbuds being worn by a user and an earbud case based on sensor data received from one or more IMU sensors; estimating a central virtual point corresponding to positions for the one or more earbuds and the earbud case based on the estimated position vectors, wherein the central virtual point indicates a static point with reference to the estimated position vectors; estimating relative position vectors of the one or more earbuds and the earbud case based on the central virtual point and RSSI values computed for signals received from the one or more earbuds; computing a yaw value and a pitch value based on the estimated relative position vectors; and positioning the earbud case based on the yaw value and the pitch value such that the position of the user is tracked by the earbud case.

### CROSS-REFERENCE TO RELATED APPLICATIONS

This application is a bypass continuation application of International Patent Application No. PCT/KR2024/015230, filed on Oct. 7, 2024, which claims priority to and is based on Indian Complete patent application No. 202341067243, filed on Oct. 4, 2024, and Indian Provisional Patent Application No. 202341067243, filed on Oct. 6, 2023, the disclosures of which are incorporated herein in their entireties by reference.

### BACKGROUND

### 1. Field

The present disclosure relates to tracking systems, and more particularly, to a method and an earbud case for tracking a position of a user.

### 2. Description of Related Art

The information in this section merely provides background information related to the present disclosure and may not constitute prior art for the present disclosure.

Unmanned aerial vehicles (UAV), commonly known as drones, may refer to aerial aircraft that may be flown without a presence of a pilot onboard, instead using operating equipment such as a remote. Further, the UAV may fly autonomously by utilizing one of many pre-programmed sets of instructions, as well as a number of built-in sensors and navigation systems.

The drones may also include tanking systems that are used for tracking and capturing objects such as users. However, these related art drones are bulky and heavy such that a user faces difficulty in carrying and setting up the drones.

Further, drones may utilize a camera-based tracking is the loss of tracking when a face is not detected or is no longer visible or requires some initial registration of the face that needs to be tracked.

More specifically, current tracking systems may heavily rely on detecting and continuously identifying a user's face. If the face of the user is obscured, turned away, or not within the camera's view, the drones may lose track of the targeted object, disrupting the tracking functionality.

Further, interruptions in tracking due to the absence or obstruction of a visible face may lead to frustration among users, impacting the overall usability and satisfaction with the drone.

Furthermore, the tracking systems use face detection and tracking algorithms may struggle to adapt to varying environmental conditions, lighting changes, or rapid movements, further complicating reliable tracking.

Moreover, the existing camera-based tracking systems may consume significant battery power, reducing the overall flight time of compact drones. This may limits the duration users can utilize tracking features before needing to recharge or replace batteries.

Therefore, there is a need for an alternative solution that may overcome above discussed limitations.

The drawbacks/difficulties/disadvantages/limitations of the related art techniques explained in the background section are just for example purposes and the disclosure would never limit its scope only such limitations. A person skilled in the art would understand that this disclosure and below mentioned description may also solve other problems or overcome the other drawbacks/disadvantages.

### SUMMARY

According to an aspect of the disclosure, a method for tracking a position of a user by an earbud case, includes: estimating position vectors in three-dimensional (3D) space for one or more earbuds being worn by the user and the earbud case based on sensor data received from one or more inertial measurement unit (IMU) sensors; estimating a central virtual point corresponding to positions for the one or more earbuds and the earbud case based on the position vectors, wherein the central virtual point indicates a static point with reference to the estimated position vectors; estimating relative position vectors of the one or more earbuds and the earbud case based on the central virtual point and received signal strength indicator (RSSI) values for signals received from the one or more earbuds; determining a yaw value and a pitch value based on the relative position vectors; and positioning the earbud case based on the yaw value and the pitch value such that the position of the user is tracked by the earbud case.

The one or more earbuds and the earbud case may include the one or more IMU sensors, and the sensor data may include at least one of accelerometer data, gyroscope data, or magnetometer data.

The method may further include determining the RSSI values based on filtering noise from the signals received from the one or more earbuds using an artificial intelligence (AI) model.

The estimating the position vectors may include: determining a velocity of the one or more earbuds and the earbud case based on integrating acceleration data over time; determining integrated position data of the one or more earbuds and the earbud case based on integrating the velocity of the one or more earbuds and the earbud case over time; determining an orientation of the one or more earbuds and the earbud case based on integrating an angular velocity of the one or more earbuds and the earbud case obtained from gyroscope data; modifying the orientation of the one or more earbuds based on magnetometer data corresponding to respective axes of the one or more earbuds and the earbud case; and estimating the position vectors based on correlating the modified orientation with the integrated position data.

The estimating the central virtual point may include: determining a centroid of the position vectors of the one or more earbuds and the earbud case based on the estimated position vectors; and estimating the central virtual point based on the centroid.

The estimating the relative position vectors may include: estimating initial relative position vectors corresponding to the one or more earbuds and the earbud case based on the estimated central virtual point; modifying the initial relative position vectors based on the RSSI values for the signals received from the one or more earbuds; and estimating the relative position vectors based on the modified initial relative position vectors.

The modifying the initial relative position vectors of the one or more earbuds and the earbud case may include: estimating a distance between a centroid vector and an initial relative position vector of the earbud case based on the RSSI values, wherein the centroid vector indicates a mid-point of the one or more earbuds; computing an error function based on the estimated distance, wherein the error function indicates a difference between the estimated distance and an actual distance obtained from the estimated position vectors; modifying the initial relative position vectors based on minimizing the error function using optimizing techniques; and, thereby estimating the relative position vectors based on the modified initial relative position vectors.

The method may further include: determining the centroid vector based on initial relative position vectors of the one or more earbuds; and determining a directional centroid vector based on normalizing the centroid vector.

The method may further include determining a modified centroid vector based on the relative position vectors.

The method may further include: receiving input from one or more cameras integrated with the earbud case in a flying state of the earbud case for capturing video, and the input indicates at least one of image data or video data associated with the user.

The method may further include capturing audio by at least performing, in real time, a predefined noise cancelation operation to minimize background noise from audio signals received from the one or more earbuds.

The one or more earbuds may include a first earbud and a second earbud, and the first earbud may be worn by the user and the second earbud may be retained in the earbud case.

The method may further include: determining one or more characteristics associated with the audio signals based on analyzing the audio signals, wherein the one or more characteristics includes frequency, amplitude, and patterns associated with the audio signals; detecting at least one of a user speech and an environmental sound based on the determined one or more characteristics, wherein the user speech is detected from audio signals corresponding to the first earbud and the environmental sound is detected from audio signals corresponding to the second earbud; dynamic switching between the first earbud and the second earbud based on the at least one of the user speech or the environmental sound; and merging a first audio stream associated with the first earbud and a second audio stream associated with the second earbud based on the dynamic switching to obtain the merged audio.

The method may further include synchronizing the merged audio and the captured video using a latency correction model and a real-time signal processing model.

According to an aspect of the disclosure, an earbud case for tracking a position of a user, includes: at least one processor; and memory storing at least one instruction, wherein the at least one instruction, when executed by the at least one processor individually or collectively, causes the system to: estimate position vectors in three-dimensional (3D) space for one or more earbuds being worn by the user and the earbud case based on receiving sensor data from one or more inertial measurement unit (IMU) sensors; estimate a central virtual point corresponding to positions for the one or more earbuds and the earbud case based on the position vectors, wherein the central virtual point indicates a static point with reference to the estimated position vectors; estimate relative position vectors of the one or more earbuds and the earbud case based on the central virtual point and a received signal strength Indicator (RSSI) value for signals received from the one or more earbuds; determine a yaw value and a pitch value based on the relative position vectors; and position the earbud case based on the yaw value and the pitch value such that the position of the user is tracked by the earbud case.

The at least one instruction, when executed by the at least one processor individually or collectively, may further cause the earbud case to: determine the RSSI value based on filtering noise from the signals received from the one or more earbuds using an artificial intelligence (AI) model.

The at least one instruction, when executed by the at least one processor individually or collectively, may further cause the earbud case to: determine a velocity of the one or more earbuds and the earbud case based on integrating acceleration data over time; determine integrated position data of the one or more earbuds and the earbud case based on integrating the velocity over time; determine an orientation of the one or more earbuds and the earbud case based on integrating an angular velocity of the one or more earbuds and the earbud case obtained from gyroscope data; modify the orientation based on magnetometer data corresponding to respective axes of the one or more earbuds and the earbud case; and estimate the position vectors based on correlating the modified orientation with the integrated position data.

The at least one instruction, when executed by the at least one processor individually or collectively, may further causes the earbud case to: determine a centroid of the position vectors of the one or more earbuds and the earbud case based on the estimated position vectors; and estimate the central virtual point based on the computed centroid.

The at least one instruction, when executed by the at least one processor individually or collectively, further causes the earbud case to: estimate initial relative position vectors corresponding to the one or more earbuds and the earbud case based on the central virtual point; modify the initial relative position vectors based on the RSSI value for the signals received from the one or more earbuds; and estimate the relative position vectors based on the modified initial relative position vectors.

According to an aspect of the disclosure, a non-transitory computer-readable storage medium has stored thereon instructions that, when executed by at least one processor of earbud case individually or collectively, cause the earbud case to: estimate position vectors in three-dimensional (3D) space for one or more earbuds being worn by a user and a earbud case based on receiving sensor data from one or more inertial measurement unit (IMU) sensors; estimate a central virtual point corresponding to positions for the one or more earbuds and the earbud case based on the position vectors, wherein the central virtual point indicates a static point with reference to the position vectors; estimate relative position vectors of the one or more earbuds and the earbud case based on the central virtual point and a received signal strength indicator (RSSI) value for signals received from the one or more earbuds; determine a yaw value and a pitch value based on the relative position vectors; and position the earbud case based on the yaw value and the pitch value such that the position of the user is tracked by the earbud case.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 illustrates a schematic block diagram of an environment for the implementation of a system for tracking a position of a user, in accordance with one or more embodiments of the present disclosure;

FIG. 2A illustrates a top view of an earbud case when the earbud case gets unfolded, in accordance with one or more embodiments of the present disclosure;

FIG. 2B illustrates an isometric view of the earbud case when the earbud case gets unfolded, in accordance with one or more embodiments of the present disclosure;

FIG. 2C illustrates an isometric view of the earbud case when the earbud case gets folded, in accordance with one or more embodiments of the present disclosure;

FIG. 2D illustrates a bottom view of the earbud case when the earbud case gets folded, in accordance with one or more embodiments of the present disclosure;

FIG. 3 is a flowchart of an example method for enabling the earbud case capable of flying, in accordance with one or more embodiments of the present disclosure;

FIG. 4 illustrates a schematic block diagram of the system for tracking the position of the user, in accordance with one or more embodiments of the present disclosure;

FIG. 5 is a flowchart depicting an example method for tracking the position of the user, in accordance with one or more embodiments of the present disclosure;

FIG. 6 is a flowchart of the generation of the raw data stream from the sensor data, in accordance with one or more embodiments of the present disclosure;

FIG. 7 illustrates a schematic diagram of blocks for processing raw data stream, in accordance with one or more embodiments of the present disclosure;

FIG. 8 is a flowchart of sub-steps for estimating position vectors of one or more earbuds and the earbud case, in accordance with one or more embodiments of the present disclosure;

FIG. 9 is a flowchart of sub-steps for estimating a central virtual point corresponding to positions for the one or more earbuds and the earbud case, in accordance with one or more embodiments of the present disclosure;

FIG. 10 is a flowchart of a filtration of noise from signals, in accordance with one or more embodiments of the present disclosure;

FIG. 11 is a flowchart of sub-steps for modifying the initial relative position vectors for estimating, using the estimating module, the optimized relative position vectors, in accordance with one or more embodiments of the present disclosure;

FIG. 12 is a flowchart of steps for obtaining a merged audio, in accordance with one or more embodiments of the present disclosure;

FIG. 13 illustrates an example flow of dynamic switching, in accordance with one or more embodiments of the present disclosure;

FIG. 14 illustrates a schematic diagram of blocks for synchronization of audio and video, in accordance with one or more embodiments of the present disclosure; and

FIGS. 15A to 15E illustrate an example use case, in accordance with one or more embodiments of the present disclosure.

### DETAILED DESCRIPTION

For the purpose of promoting an understanding of the principles of the invention, reference will now be made to the various embodiments and specific language will be used to describe the same. It should be understood at the outset that although illustrative implementations of the embodiments of the present disclosure are illustrated below, the present invention may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

It will be understood by those skilled in the art that the foregoing general description and the following detailed description are explanatory of the invention and are not intended to be restrictive thereof.

Further, skilled artisans will appreciate that elements in the drawings are illustrated for simplicity and may not have necessarily been drawn to scale. For example, the flowcharts illustrate methods in terms of the most prominent steps involved to help improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

Reference throughout this specification to “an aspect”, “another aspect” or similar language means that a particular feature, structure, or characteristic described in connection with the embodiment is included in at least one embodiment of the present invention. Thus, appearances of the phrase “in one or more embodiments”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Recitation of ranges of values herein is merely intended to serve as a shorthand method of referring individually to each separate value falling within the range, unless otherwise indicated. Each separate value is incorporated into the specification as if it were individually recited herein.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

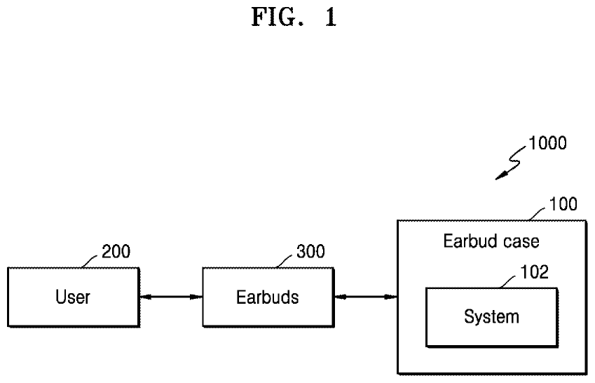

FIG. 1 illustrates a schematic block diagram of an environment 1000 for the implementation of a system 102 for tracking a position of a user 200, in accordance with one or more embodiments of the present disclosure. In one or more embodiments, the environment 1000 may include an earbud case 100 that is capable of flying. The environment 1000 may include one or more earbuds 300 that may be worn by the user 200. In one or more embodiments, the one or more earbuds 300 may be retained in the earbud case 100. In one or more embodiments, the system 102 may be implemented in the earbud case 100 and may be capable of tracking the position of the user 200. In various embodiments, the system 102 may refer to a vision-less tracking system (VTS).

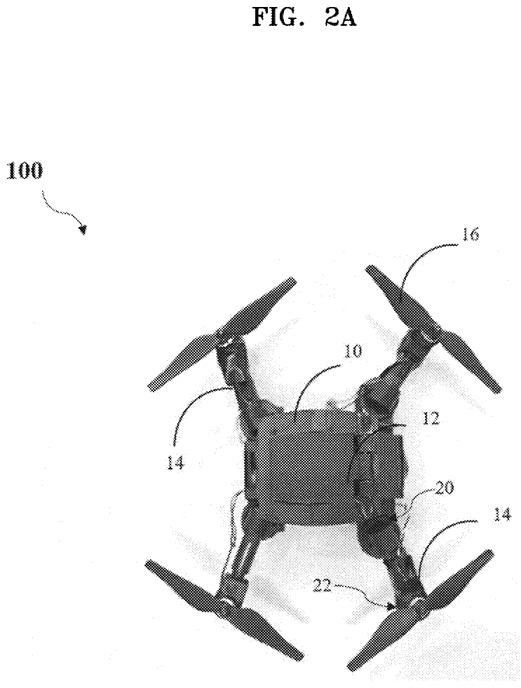

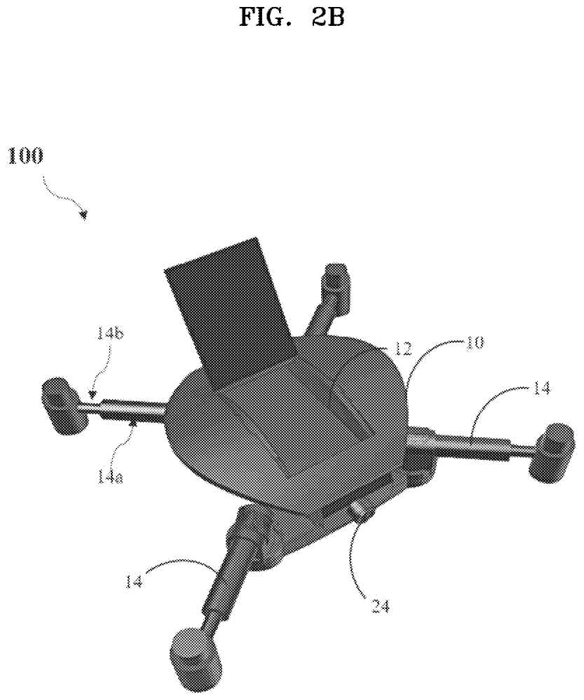

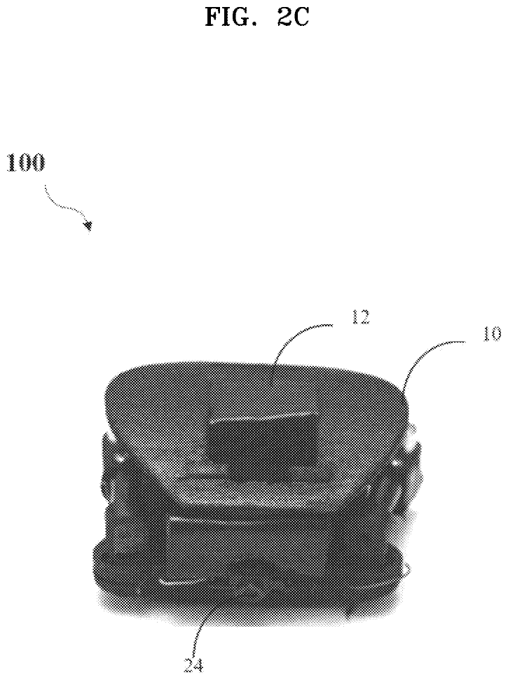

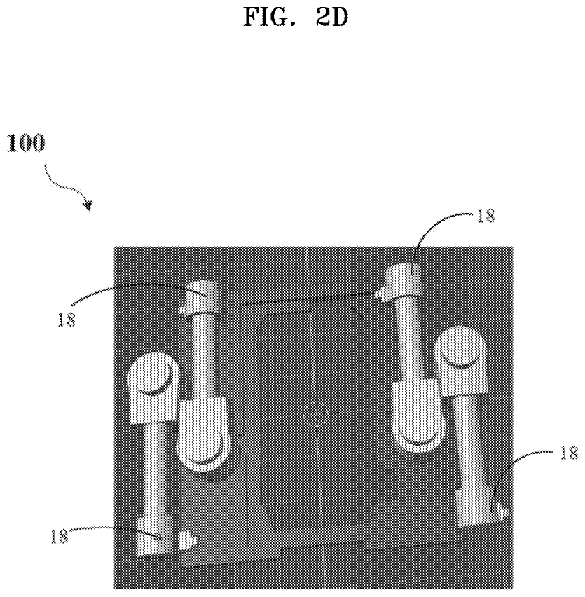

In one or more embodiments, construction details of the earbud case 100 may be described in conjunction with FIGS. 2A, 2B, 2C, and 2D.

FIG. 2A illustrates a top view of the earbud case 100 when the earbud case 100 gets unfolded, in accordance with one or more embodiments of the present disclosure. FIG. 2B illustrates an isometric view of the earbud case 100 when the earbud case 100 gets unfolded, in accordance with one or more embodiments of the present disclosure. FIG. 2C illustrates an isometric view of the earbud case 100 when the earbud case 100 gets folded, in accordance with one or more embodiments of the present disclosure. FIG. 2D illustrates a bottom view of the earbud case 100 when the earbud case 100 gets folded. The earbud case 100 may include, without limitation, a body 10, one or more arms 14, one or more actuating units, and a control unit. In one or more embodiments, the body 10 may include a shell 12 (as illustrated in FIGS. 2A and 2B) that may be retain the one or more earbuds 300 (not shown in FIGS. 2A, 2B, 2C, and 2D). In one or more embodiments, the body 10 may include a battery retaining unit (not shown in FIGS.) that may retain one or more batteries. In one or more embodiments, the one or more batteries may power various components of the earbud case 100 such as the one or more earbuds 300 case or the one or more actuating units.

Further, the earbud case 100 may include the one or more arms 14 that may be mounted on the body 10. In one or more embodiments, each of the one or more arms 14 may include a proximal end 20 and a distal end 22 as illustrated in FIG. 2A.

In one or more embodiments, the proximal end 20 may be coupled to the body 10. The proximal end 20 may include a rotary device 18 that connects a corresponding arm to the body 10. In an example embodiment, the rotary device 18 may refer to a hinge.

In one or more embodiments, each of the one or more arms 14 may include, without limitation, a first telescopic cylinder 14a and a second telescopic cylinder 14b. In one or more embodiments, the first telescopic cylinder 14a may be coupled to a corresponding rotary device 18. In one or more embodiments, the second telescopic cylinder 14b may fit inside the first telescopic cylinder 14a. In various implementations, the second telescopic cylinder 14b may slide inside the first telescopic cylinder 14a, thereby enabling extension and retraction of the corresponding arm.

In one or more embodiments, the first telescopic cylinder 14a may include a locking through-hole on its circumferential surface. When the second telescopic cylinder 14b extends to a predefined range, a protruded part of the second telescopic cylinder 14b may engage with this through-hole. As a result, this may lock the second telescopic cylinder 14b and the first telescopic cylinder 14a when the one or more arms 14 are unfolded.

In one or more embodiments, the distal end 22 may be provided with a propulsion unit 16 that may generate thrust as illustrated in FIG. 2A. In one embodiment, the propulsion unit 16 may be coupled to the distal end 22 such that the propulsion unit 16 may also get detached as illustrated in FIG. 2A. In one or more embodiments, the propulsion unit 16 may include a propeller that may be coupled to the one or more actuating units.

In one embodiment, the one or more actuating devices (not shown in FIGS.) may be operably coupled to the one or more arms 14 and the propulsion unit 16. In one or more embodiments, the one or more actuating units may drive each of the one or more arms 14, and the propulsion unit 16. More specifically, the one or more actuating units may provide a rotational force to drive the propeller.

In one or more embodiments, the one or more actuating units may drive the rotary device 18 to enable rotation of the corresponding arm such that the corresponding arm extends from the body 10.

In one embodiment, the earbud case 100 may further include a control unit that may communicate with the one or more actuating units. In one or more embodiments, the control unit may be configured to generate one or more instructions based on receiving input from the user 200. In an example embodiment, the input may indicate a voice command from the user 200 for folding the one or more arms 14 or unfolding the one or more arms 14.

In one or more embodiments, the one or more instructions may include commands to operate the one or more actuating units to perform one or more functions. In one or more embodiments, the one or more functions may include unfolding the one or more arms 14. The unfolding may refer to an extension of the one or more arms 14 from the body 10. The one or more functions may further include operating the propulsion unit 16 upon unfolding the one or more arms 14, thereby enabling the earbud case 100 to fly.

In one or more embodiments, the one or more actuating units may drive the rotary device 18 to enable rotation of the corresponding arm such that the corresponding arm extends from the body 10.

In one or more embodiments, the one or more actuating units may drive the rotary device 18 to enable rotation of the corresponding arm such that the corresponding arm gets folded under the body 10 as illustrated in FIG. 2D.

In one or more embodiments, the earbud case 100 may include one or more cameras 24 that may be mounted on the body 10. In one or more embodiments, the one or more cameras 24 may capture videos/images.

In one or more embodiments, the earbud case 100 and the one or more earbuds 300 may be installed with one or more Inertial Measurement Unit (IMU) sensors.

In one or more embodiments, the earbud case 100 may be capable of tracking the position of the user 200.

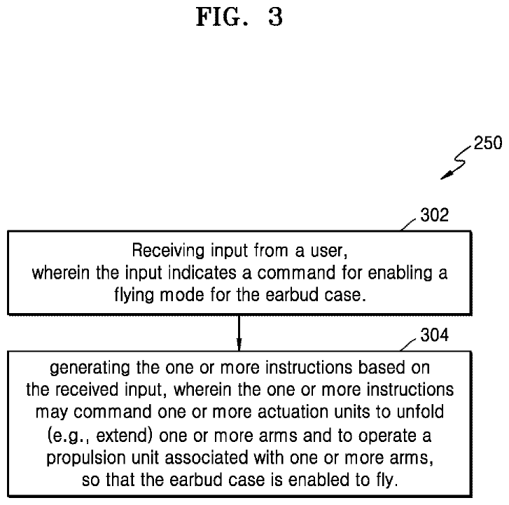

FIG. 3 is a flowchart of an example method 250 for enabling an earbud case 100 capable of flying, in accordance with one or more embodiments of the present disclosure. In the following embodiments, operations may be performed sequentially, in a different order, in parallel, or with some operations skipped or repeated.

At step 302, the method 250 may include receiving input from the user 200. In one or more embodiments, the input indicates a command for enabling a flying mode for the earbud case 100.

At step 304, the method 250 may further include generating the one or more instructions based on the received input. In one or more embodiments, the one or more instructions may command one or more actuation units to unfold one or more arms 14 and to operate a propulsion unit 16 associated with one or more arms 14. This may enable the earbud case 100 to fly.

In one or more embodiments, the method 250 may further include driving, by the one or more actuating units, the rotary device 18 associated with each of the one or more arms 14 to enable rotation of the corresponding arm such that the corresponding arm extends from the body 10. As a result, the one or more arms 14 may be unfolded.

In one or more embodiments, the method 250 may further include providing, by the one or more actuating units, the rotational force to the propeller associated with the propulsion unit 16 for generating thrust and enabling flight.

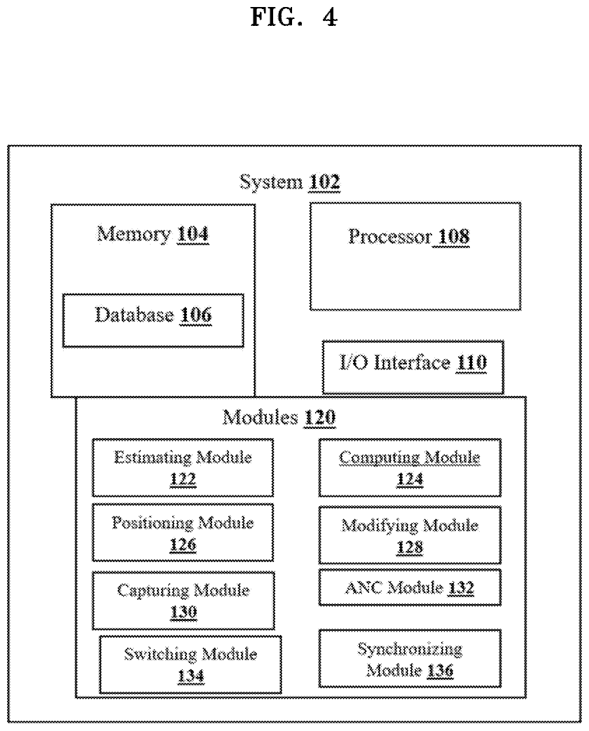

FIG. 4 illustrates a schematic block diagram of the system 102 for tracking the position of the user 200, in accordance with one or more embodiments of the present disclosure.

In one or more embodiments, the system 102 may include memory 104 including a database 106. In one or more embodiments, the system 102 may include at least one processor 108 that is configured to communicate with the memory 104, an Input/Output (I/O) interface 110, and a plurality of modules 120. In one or more embodiments, the system 102 may be implemented by the earbud case 100.

In another embodiment, the system 102 may be implemented by a cloud-based system, which may include a cloud server that may be communicate with the earbud case 100 and the one or more earbuds 300.

In yet another embodiment, the system 102 may be implemented by user equipment (UE) that may be in communication with the earbud case 100 and the one or more earbuds 300. In a non-limiting example, the UE may be a smartphone, a laptop computer, a desktop computer, a Personal Computer (PC), a notebook, a tablet, or a smartwatch.

In one embodiment, the memory 104 may be configured to store instructions executable by the processor 108. In one embodiment, the memory 104 may communicate via a bus within the system 102. The memory 104 may include but is not limited to, a non-transitory computer-readable storage media, such as various types of volatile and non-volatile storage media including, without limitation, random access memory, read-only memory, programmable read-only memory, electrically programmable read-only memory, electrically erasable read-only memory, flash memory, magnetic tape or disk, optical media and the like. In one example, the memory may include a cache or random-access memory (RAM) for the processor 108. In alternative examples, the memory 104 may be separate from the processor 108 such as a cache memory of a processor, the system memory, or other memory. The memory 104 may be an external storage device and the memory 104 is for storing data. The memory 104 may be operable to store instructions executable by the processor 108. The functions, acts, or tasks illustrated in the FIGS. or described are performed by the programmed processor for executing the instructions stored in the memory 104. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies include multiprocessing, multitasking, parallel processing, and the like.

As a non-limiting example, the processor 108 may be a single processing unit or a set of units each including multiple computing units. The processor 108 may be implemented based on at least one of: microprocessors, microcomputers, microcontrollers, digital signal processors, central processing units, state machines, logic circuitries, or any devices that manipulate signals based on operational instructions (computer-readable instructions) stored in the memory 104. Among other capabilities, the processor 108 may be configured to fetch and execute computer-readable instructions and data stored in the memory 104. The processor 108 includes one or a plurality of processors. The plurality of processors may be further implemented as a general-purpose processor, such as a Central Processing Unit (CPU), an Application Processor (AP), or the like, a graphics-only processing unit, such as a Graphics Processing Unit (GPU), a Visual Processing Unit (VPU), and/or an AI-dedicated processor such as a Neural Processing Unit (NPU). The plurality of processors may control the processing of the input data in accordance with a predefined operating rule or an Artificial Intelligence (AI) model stored in the memory 104. The predefined operating rule or the AI model is provided through training or learning.

The processor 108 may communicate with one or more Input/Output (I/O) devices via the Input/Output (I/O) interface 110. The I/O interface 110 may employ Communication Code-Division Multiple Access (CDMA), High-Speed Packet Access (HSPA+), Global System for Mobile communications (GSM), Long-Term Evolution (LTE), WiMax, and the like, etc. Alternatively, the I/O interface 110 may employ ethernet, industrial wireless Local Area Network (LAN), Process Field Bus (PROFIBUS), Actuator Sensor (AS) Interface, and the like.

In various embodiments, the processor 108 may refer to the control unit described herein.

The system 102 may further include a plurality of modules 120 that may include the one or more instructions that may be executed by the processor 108 to cause the system 102, to perform various operations described herein.

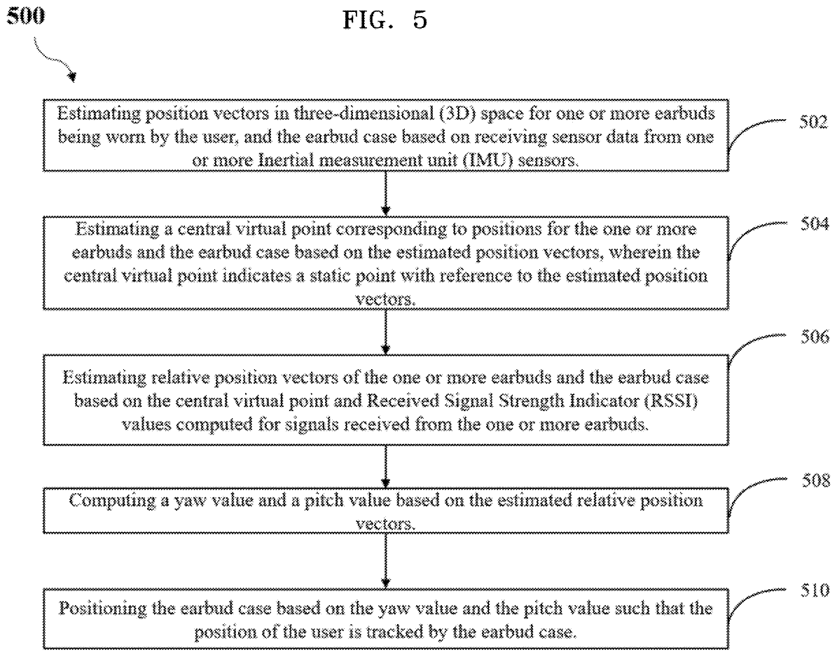

The plurality of modules 120 may include an estimating module 122, a computing module 124, a positioning module 126, a modifying module 128, a capturing module 130, an active noise cancelling (ANC) module 132, a switching module 134, and a synchronizing module 136. In one or more embodiments, the estimating module 122, the computing module 124, the positioning module 126, the modifying module 128, the capturing module 130, the active noise cancelling (ANC) module 132, the switching module 134, and the synchronizing module 136 may be communicate with each other. In one or more embodiments, the plurality of modules 120 may be configured to perform various operations or steps that may be discussed and explained in detail in conjunction with FIGS. 5 to 14.

Various functions of the processor 108, and/or the plurality of modules 120 may be explained in view of FIGS. 5 to 14.

FIG. 5 is a flowchart of an example method 500 for tracking the position of the user 200, in accordance with one or more embodiments of the present disclosure. In the following embodiments, operations may be performed sequentially, in a different order, in parallel, or with some operations skipped or repeated.

Referring to FIG. 5, the method 500 may begin with step 502 which may include estimating, via the estimating module 122, position vectors in Three-Dimensional (3D) space for the one or more earbuds 300 being worn by the user 200, and the earbud case 100. In an example embodiment, the one or more earbuds 300 herein may refer to a pair of earbuds (e.g., a left earbud and a right earbud).

In one or more embodiments, the position vectors may be estimated using sensor data that may be received from the one or more Inertial Measurement Unit (IMU) sensors. In one or more embodiments, the sensor data may include at least one of accelerometer data, gyroscope data, or magnetometer data. In one or more embodiments, the IMU sensors may be installed on the one or more earbuds 300 and the earbud case 100.

In one or more embodiments, the method 500 may also include receiving input from the one or more cameras 24 integrated with the earbud case 100, in a flying state of the earbud case 100. The input indicates image and video data associated with the user 200.

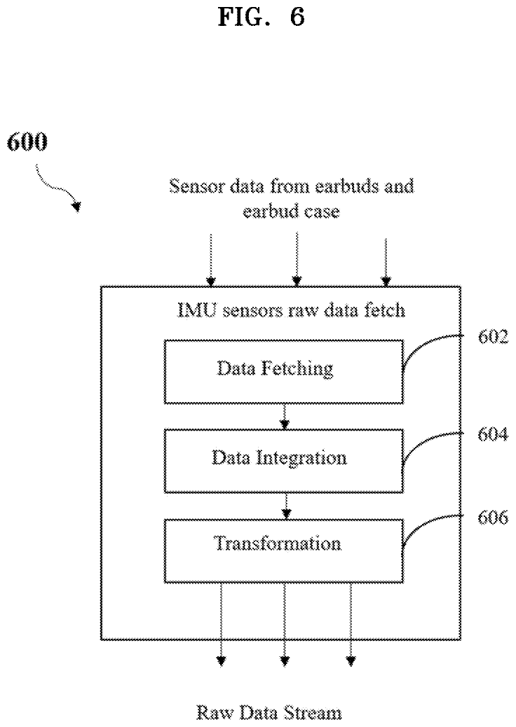

In one or more embodiments, prior to estimating the position vectors, the sensor data may be processed to generate a raw data stream which may be discussed in conjunction with FIG. 6.

FIG. 6 is a flowchart 600 of the generation of the raw data stream from the sensor data, in accordance with one or more embodiments of the present disclosure. In the following embodiments, operations may be performed sequentially, in a different order, in parallel, or with some operations skipped or repeated.

At block 602, a data fetching module may fetch the sensor data from the one or more IMU sensors of each of the one or more earbuds 300 and the earbud case 100. The data fetching model may further analyze the sensor data at a specified sampling rate or on-demand basis.

Furthermore, at block 604, a data integration model may integrate the analyzed sensor data received from the IMU sensors associated with each of the one or more earbuds 300 and the earbud case 100. The integration may include at least one of aligning timestamps, handling any sensor-specific calibration or normalization, or ensuring data consistency across the sensor data.

Furthermore, at block 606, a transformation model may process the integrated sensor data and transform the integrated sensor data into the raw data stream. The raw data stream may include numerical values representing sensor readings at discrete time intervals. In an example embodiment, the numerical values may include at least one of acceleration values (in the x, y, and z axes), angular velocities, or magnetic field strengths associated with the one or more earbuds 300 and the earbud case 100.

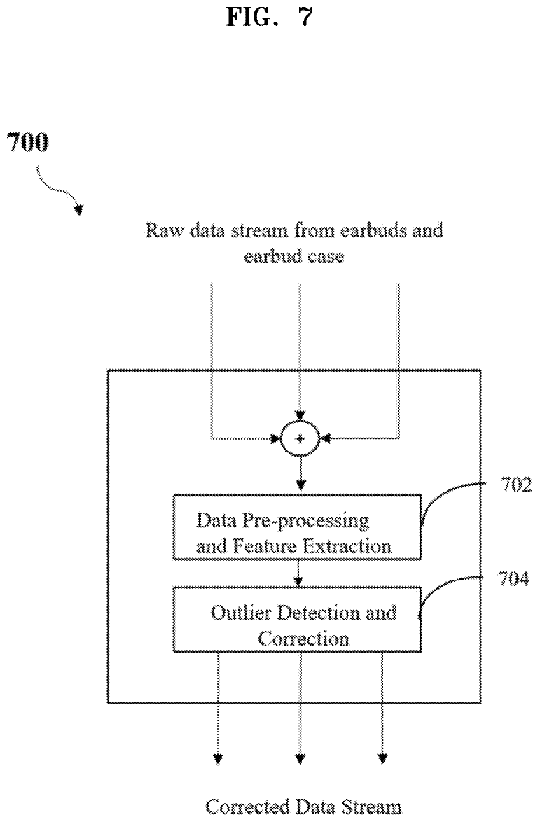

FIG. 7 illustrates a schematic diagram 700 of blocks for processing the raw data stream, in accordance with one or more embodiments of the present disclosure. In the following embodiments, operations may be performed sequentially, in a different order, in parallel, or with some operations skipped or repeated.

At block 702, a data pre-processing and feature extraction model may parse the raw data stream to separate data received from the one or more IMU sensors. Furthermore, the data pre-processing and feature extraction model may normalize the separated data to a common scale to extract relevant features from the parsed and normalized data.

At block 704, an outlier detection and correction model may identify outliers in the position vectors using statistical methods and learned patterns from training data and apply corrections to the identified outliers to produce a refined data stream.

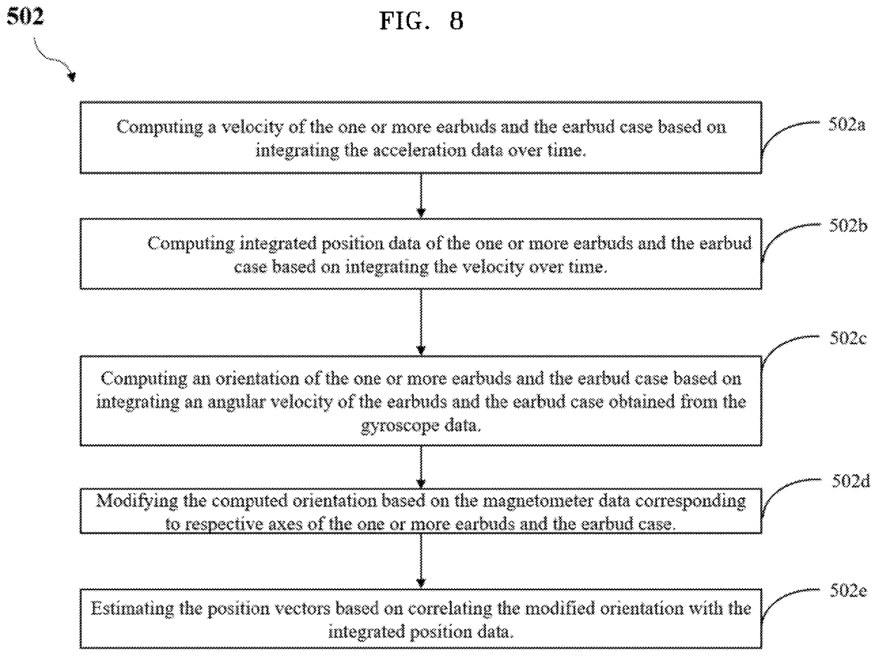

Again, referring to step 502, one or more sub-steps for estimating the position vectors are discussed in conjunction with FIG. 8.

FIG. 8 is a flowchart of sub-steps for estimating the position vectors of the one or more earbuds 300 and the earbud case 100, in accordance with one or more embodiments of the present disclosure. In the following embodiments, operations may be performed sequentially, in a different order, in parallel, or with some operations skipped or repeated.

At sub-step 502a, the step 502 may include computing, via the computing module 124, a velocity v(t) of the one or more earbuds 300 and the earbud case 100 based on integrating the acceleration data over time using math FIG. 1 as illustrated below:

$$( t ) = v ( t - 1 ) + ( t ) . Δ t \qquad [ Math FIG . 1 ]$$

where (t) may refer to acceleration data over time and Δt may refer to a change in time.

At sub-step 502b, the step 502 may include computing integrated position data of the one or more earbuds 300 and the earbud case 100 based on integrating the velocity over time using math FIG. 2 as below:

$$p ( t ) = p ( t - 1 ) + v ( t ) . Δ t \qquad [ Math FIG . 2 ]$$

where v(t) may correspond to computed velocity over time.

At sub-step 502c, the step 502 may include computing an orientation (γ) of the one or more earbuds 300 and the earbud case 100 based on integrating an angular velocity of the earbuds and the earbud case 100 obtained from the gyroscope data using math FIG. 3 as below:

$$γ gyro ( t ) = γ gyro ( t - 1 ) + ω gyro ( t ) . Δ t \qquad [ Math FIG . 3 ]$$

where ω_{gyro}(t) may correspond to angular frequency over time.

At sub-step 502d, the step 502 may include modifying, via the modifying module 128, the computed orientation based on the magnetometer data corresponding to the respective axes of the one or more earbuds 300 and the earbud case 100 using math FIG. 4 as below:

$${γ}_{corr} ( t ) = α {γ}_{gyro} ( t ) + ( 1 - α ) {γ}_{mag} ( t ) \qquad [ Math FIG . 4 ]$$

where γ_{mag}(t) may refer to arctan (B₁, B₂), a may correspond to a constant ranging from 0 to 1, and B₁, B₂ may refer to the magnetic field components corresponding to the respective axes.

At sub-step 502e, the step 502 may include estimating the position vectors based on correlating the modified orientation with the integrated position data. In one or more embodiments, the position vectors (P) may be computed by applying the orientation correction to the integrated positions using math FIG. 5 as below:

$$P ( t ) = R ( {γ}_{corr} ( t ) ) . p ( t ) \qquad [ Math FIG . 5 ]$$

where R(γ_{corr}(t)) may correspond to the rotation matrix over time derived from the orientation data.

In one or more embodiments, the rotation matrix associated with the one or more earbuds 300 and the earbud case 100 may be computed using math FIG. 6 as below:

$$R ( {γ}_{corr} ( t ) ) = {R}_{x} ( φ ) . Ry ( θ ) . Rz ( ψ ) \qquad [ Math FIG . 6 ]$$

where Rx(φ) may correspond to the rotation matrix for Roll(φ) represented using math FIG. 7 as below:

$${R}_{x} ( φ ) = [ \begin{matrix}1 & 0 & 0 \\ 0 & cos ( φ ) & - sin ( φ ) \\ 0 & sin ( φ ) & cos ( φ )\end{matrix} ] \qquad [ Math FIG . 7 ]$$

where R_{y}(θ) may correspond to the rotation matrix for Pitch(θ) represented using math FIG. 8 as below:

$$Ry ( θ ) = [ \begin{matrix}cos ( θ ) & 0 & sin ( θ ) \\ 0 & 1 & 0 \\ - sin ( θ ) & 0 & cos ( θ )\end{matrix} ] \qquad [ Math FIG . 8 ]$$

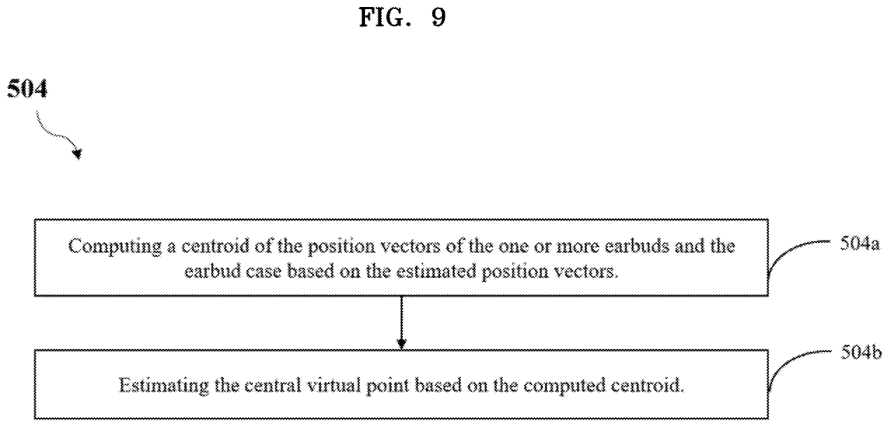

and where Rz(ψ) may correspond to the rotation matrix for Yaw(ψ) represented using math FIG. 9 as below:

$$Rz ( ψ ) = [ \begin{matrix}cos ( ψ ) & - sin ( ψ ) & 0 \\ sin ( ψ ) & cos ( ψ ) & 0 \\ 0 & 0 & 1\end{matrix} ] \qquad [ Math FIG . 9 ]$$

Again, referring to FIG. 5, at step 504, the method 500 may include estimating, via the estimating module 122, a central virtual point corresponding to positions for the one or more earbuds 300 and the earbud case 100 based on the estimated position vectors. In one or more embodiments, the central virtual point may indicate a static point with reference to the estimated position vectors.

In one or more embodiments, the estimation of the central virtual point may be discussed in conjunction with FIG. 9.

FIG. 9 is a flowchart of sub-steps for estimating the central virtual point corresponding to positions for the one or more earbuds 300 and the earbud case 100, in accordance with one or more embodiments of the present disclosure. In the following embodiments, operations may be performed sequentially, in a different order, in parallel, or with some operations skipped or repeated.

At sub-step 504a, the step 504 may include computing a centroid of the position vectors of the one or more earbuds 300 and the earbud case 100 based on estimated position vectors.

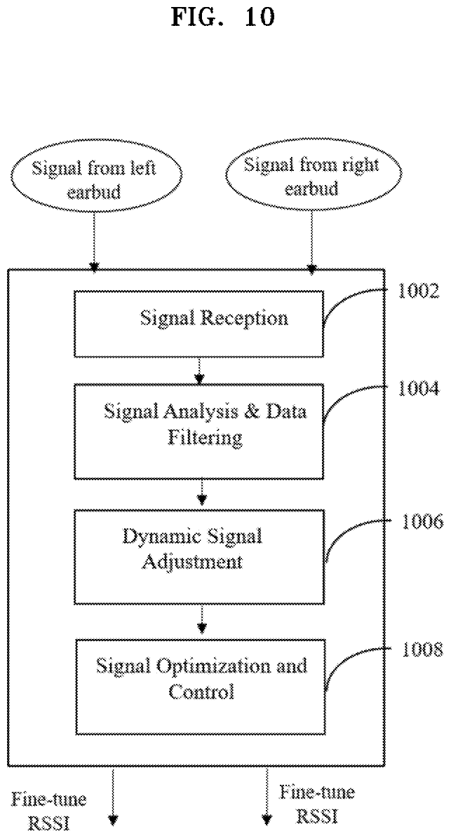

At sub-step 504b, the step 504 may include estimating the central virtual point based on the computed centroid using math FIG. 10 as below:

$$\vec{V} = ( XA + XB + XC ) / 3 \qquad [ Math FIG . 10 ]$$

where XA may correspond to a position vector corresponding to the left earbud in the 3D space, XB may correspond to a position vector corresponding to the right earbud in the 3D space, and XC may correspond to a position vector corresponding to the earbud case 100 in the 3D space.

Again, referring to FIG. 5, at step 506, the method 500 may include estimating, via the estimating module 122, relative position vectors of the one or more earbuds 300 and the earbud case 100 based on the central virtual point and Received Signal Strength Indicator (RSSI) values computed for signals received from the one or more earbuds 300.

In one embodiment, the computing module 124 may be configured to compute the RSSI value based on filtering noise from the signals received from the one or more earbuds 300 using an Artificial Intelligence (AI) model such as a machine learning model.

In one embodiment, a signal fine tuner may be used to filter noise for the signals received from the one or more earbuds 300, specifically from each of the left earbud and the right earbud.

FIG. 10 is a flowchart of the filtration of noise from the signals, in accordance with one or more embodiments of the present disclosure. In the following embodiments, operations may be performed sequentially, in a different order, in parallel, or with some operations skipped or repeated.

Firstly, at block 1002, the signals may pass from a signal reception model. In one or more embodiments, the signal reception model may continuously monitor and receive signals from the one or more earbuds 300. In one or more embodiments, the signal reception model may obtain data corresponding to an environment that may affect signal strength. In an example scenario, the data may include interference levels, obstacles, user movement, or the like.

Thereafter, at step 1004, the signals received from the left earbud and the right earbud may pass to a signal analysis model. In one or more embodiments, the signal analysis model may filter the signals to remove fluctuations from the signals. Further, the signals may be analyzed to determine the quality of the signals and identify any issues associated with the signals such as weak signals or interference in the signals.

Furthermore, at step 1006, the analyzed signals may be passed to a signal adjustment model. In one or more embodiments, the signal adjustment model may dynamically adjust one or more parameters associated with the analyzed signals.

At step 1008, the signals may be passed to a signal optimization model for computing the RSSI values for signals associated with the one or more earbuds 300. In one or more embodiments, the RSSI values computed are enhanced and stable. In one or more embodiments, the optimized signals may adapt to changing environmental conditions and user movements to maintain optimal signal strength.

Referring to step 506, the estimating module 122 may be configured to estimate initial relative position vectors corresponding to the one or more earbuds 300 and the earbud case 100 based on the estimated central virtual point.

Further, the initial relative position vectors may be modified based on the computed RSSI values, thereby estimating the relative position vectors of the one or more earbuds 300 and the earbud case 100. More specifically, the estimated relative position vectors herein may refer to optimized relative position vectors associated with the one or more earbuds 300 and the earbud case 100.

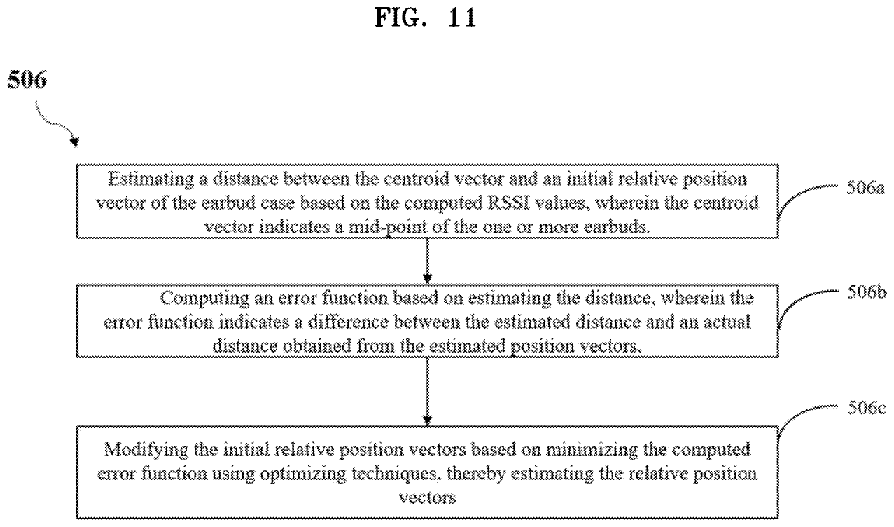

FIG. 11 is a flowchart of sub-steps for modifying the initial relative position vectors for estimating, using the estimating module 122, the optimized relative position vectors, in accordance with one or more embodiments of the present disclosure. In the following embodiments, operations may be performed sequentially, in a different order, in parallel, or with some operations skipped or repeated.

At sub-step 506a, the step 506 may include estimating a distance (d) between a centroid vector and an initial relative position vector of the earbud case 100 based on the computed RSSI values. In one or more embodiments, the centroid vector may indicate a mid-point of the one or more earbuds 300 (e.g., the leaf earbud and the right earbud). The distance may be estimated using math FIG. 11 as below:

$$d = {d}_{o} * {10}^{( {RSSI}_{o} - RSSI / 10 * n )} \qquad [ Math FIG . 11 ]$$

where dₒ may refer to reference distance kept 1 m, n may refer to path loss component, RSSIₒ may refer to RSSI values at reference distance, and RSSI may refer to measured RSSI values at d distance.

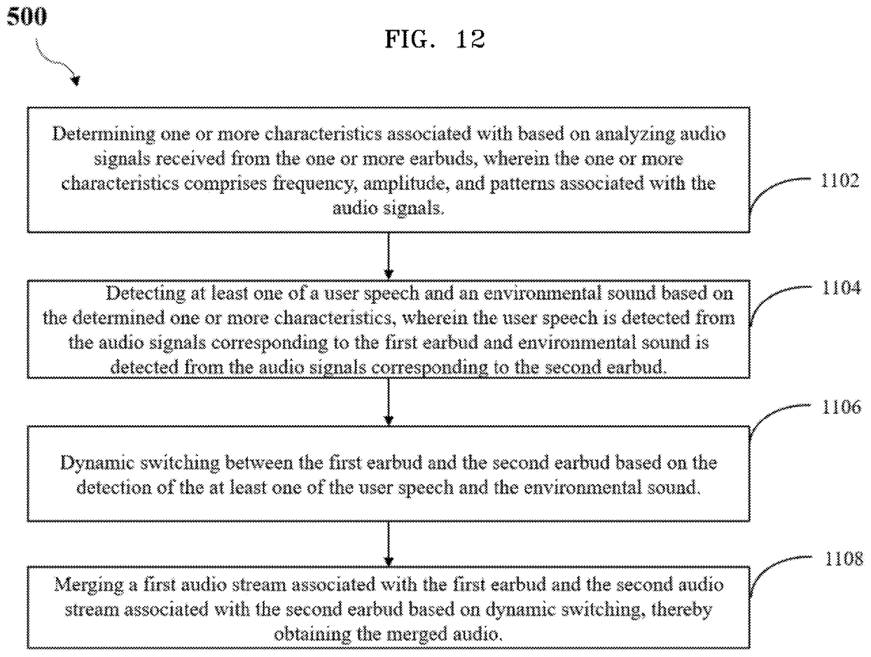

In one embodiment, the centroid vector \vec{P}_{centroid} may be computed based on the initial position vectors of the one or more earbuds 300 using math FIG. 12 as below:

$${\vec{P}}_{centroid} = \frac{( {\vec{P}}_{AV +} {\vec{P}}_{BV} )}{2} \qquad [ Math FIG . 12 ]$$

where \vec{P}_{AV} may correspond to initial position vector of the left earbud and \vec{P}_{BV} may correspond to initial position vector of the right earbud.

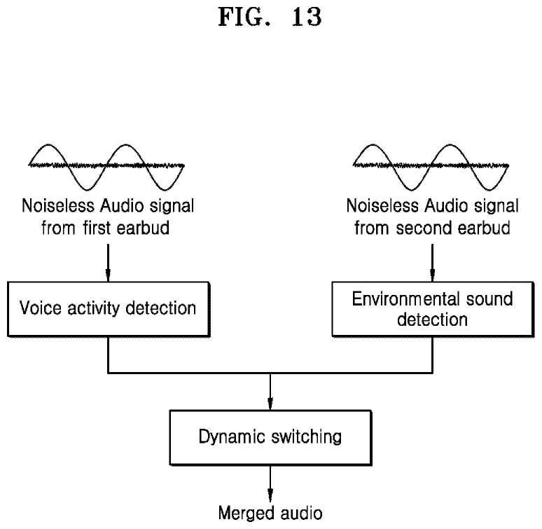

In one embodiment, the computing module 124 may be configured to compute a directional centroid vector \vec{d}_{centroid} based on normalizing the first centroid using math FIG. 13 as below:

$${\vec{d}}_{centroid} = \frac{{\vec{P}}_{centroid}}{\vert {\vec{P}}_{centroid} \vert} \qquad [ Math FIG . 13 ]$$

Again, referring to FIG. 5, at step 508, the method 500 may include computing, via the computing module 124, a yaw value and a pitch value based on the estimated relative position vectors.

In one embodiment, firstly, an initial yaw value and an initial value may be computed using the directional centroid vector. More specifically, yaw may indicate a rotation around the Z-axis. The initial yaw value may be computed using the X and Y components of the directional centroid vector. Further, pitch may refer to the rotation around the Y-axis. The initial pitch value may be computed using the Z component of the directional centroid vector.

Again, referring to FIG. 11, at sub-step 506b, the step 506 may include computing an error function (E) based on estimating the distance using at least squares method. In one or more embodiments, the error function (E) may indicate a difference between the estimated distance and an actual distance obtained from the estimated position vectors.

At sub-step 506c, the step 506 may include modifying, via the modifying module 128, the initial relative position vectors based on minimizing the computed error function (E) using optimizing techniques, thereby estimating the relative position vectors (e.g., the optimized relative position vectors). In a non-limiting example, the optimizing techniques may include a gradient descent technique or a Levenberg-Marquard technique. This step may refine the relative position vectors to better match the distances indicated by the RSSI values.

In one embodiment, the centroid vector may again be recomputed based on the estimated relative position vectors. Thereafter, the directional centroid vector may again be computed as discussed in the above paragraphs. Further, the yaw value and the pitch value may be computed as discussed in the above paragraphs. The yaw value and the pitch value may be final and refined values.

Again, referring to FIG. 5, at step 510, the method 500 may include positioning, via the positioning module 126, the earbud case 100 based on the yaw value and the pitch value such that the position of the user 200 may be tracked by the earbud case 100.

In one embodiment, the method 500 may include capturing, via the capturing module 130, audio. In one or more embodiments, the audio signals received from the one or more earbuds 300 may be processed using an active noise cancelling (ANC) module to minimize background noise, using a predefined noise cancelation technique from the audio signals received from the one or more earbuds 300 in real-time.

In an example embodiment, the one or more earbuds 300 may include a first earbud that may be worn by the user 200. Further, the one or more earbuds 300 may include a second earbud that may be retain in the earbud case 100. In an example scenario, the first earbud may be the left earbud and the second earbud may be the right earbud. In another example scenario, the first earbud may be the right earbud and the second earbud may be the left earbud.

In one or more embodiments, the ANC module 132 may include an adaptive filtering technique such as an LMS (Least Mean Squares) Adaptive Filter for generating anti-noise signals to cancel out unwanted sounds (such as rotor of the one or more actuating units and ambient noise), while preserving important audio signals like the user's voice.

FIG. 12 is a flowchart of steps for obtaining a merged audio, in accordance with one or more embodiments of the present disclosure. In the following embodiments, operations may be performed sequentially, in a different order, in parallel, or with some operations skipped or repeated.

At step 1202, the method 500 may include determining one or more characteristics based on analyzing the audio signals received from the first earbud and the second earbud respectively. In one or more embodiments, the one or more characteristics may include but are not limited to frequency, amplitude, and audio patterns.

At step 1204, the method 500 may include detecting at least one of a user speech or an environmental sound based on the determined one or more characteristics. In embodiment, the user speech may be detected from the audio signals corresponding to the first earbud, and environmental sound may be detected from the audio signals corresponding to the second earbud.

In one or more embodiments, the system 102 may utilize a voice activity detection model to detect the user speech from the audio signals of the first earbud as illustrated in FIGS. 12 and 13. In one or more embodiments, the audio signals may be noise-less audio signals. More specifically, the voice activity detection model may analyze the audio signals to determine the amplitude associated with the audio signals received from the first earbud. In a case, when the voice activity detection model may detect a sudden increase in signal strength, the voice activity detection model may determine the frequency of a first audio stream associated with the audio signals received from the first earbud. In one or more embodiments, the voice activity detection model may determine the patterns associated with the audio stream when the determined frequency is within a predefined threshold range. In one or more embodiments, the predefined threshold range may correspond to a range associated with the user speech.

More specifically, the voice activity detection model may determine temporal patterns like pauses, continuous vocalization, etc., thereby identifying a presence of the user speech.

In one embodiment, the system 102 may utilize an environment sound detection model to detect the environmental sound from the audio signals of the second earbud. More specifically, the environment sound detection model may analyze the audio signals to determine the frequency of a second audio stream associated with the audio signals received from the second earbud. In one or more embodiments, the system 102 may filter the rotor (that is associated with the one or more actuating units) noise of the earbud case 100 based on its lower frequency range and may isolate other sounds (such as the user speech or announcements) that occur in different frequency ranges. Further, the environment sound detection model may apply machine learning models that may be trained on environmental sound datasets to classify different sound events (e.g., the user speech, animal sounds, sound of nature, and music).

At step 1206, the method 500 may include dynamic switching, via the switching module 134, between the first earbud and the second earbud seamlessly based on the detection of the at least one of the user speech and the environmental sound as illustrated in FIGS. 12 and 13.

Furthermore, at step 1208, the method 500 may include merging the first audio stream and the second audio stream based on the dynamic switching, thereby obtaining the merged audio as illustrated in FIGS. 12 and 13.

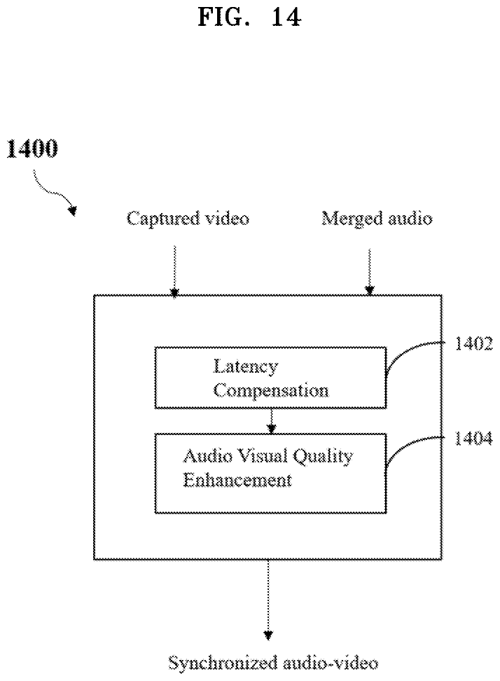

FIG. 14 illustrates a schematic diagram 1400 of blocks for synchronization of the merged audio and the captured video, in accordance with one or more embodiments of the present disclosure. In the following embodiments, operations may be performed sequentially, in a different order, in parallel, or with some operations skipped or repeated.

In one embodiment, the method 500 may include synchronizing, via the synchronizing module 136, the captured merged audio with the captured video as illustrated in FIG. 14. In one or more embodiments, the synchronizing module may utilize a combination of a latency correction model and a real-time signal processing model to ensure that the captured merged audio is perfectly aligned with the captured video.

Referring to FIG. 14, at block 1404, the latency correction model may be configured to compensate for any latency introduced by the ANC or the dynamic switching, so that the captured merged audio is matched frame by frame with the captured video.

At block 1404, the real-time signal processing model may be configured to improve an overall audio-visual experience by ensuring that transitions (like audio switching between earbuds) are smooth and imperceptible to the user 200, The final output may be optimized for both audio clarity and video coherence, producing a high-quality, post-processing-free video ready for immediate publication.

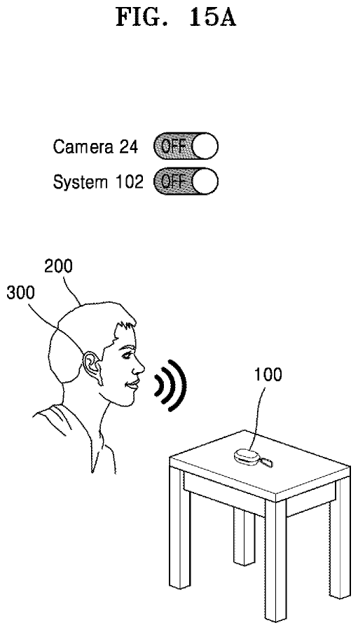

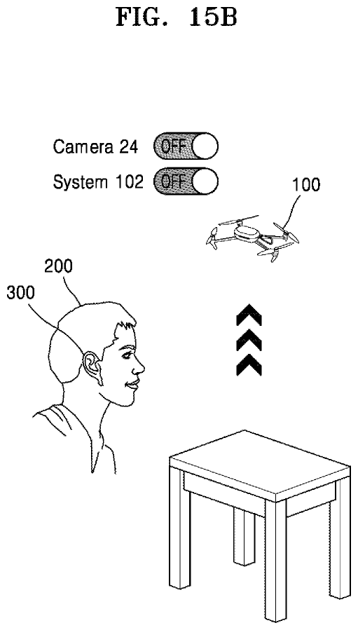

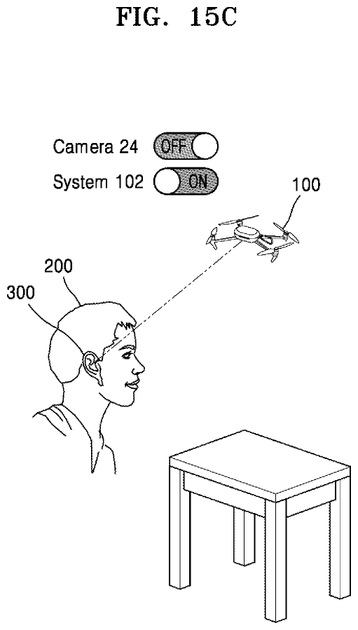

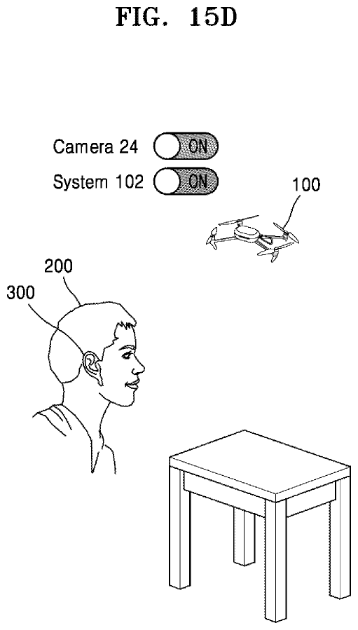

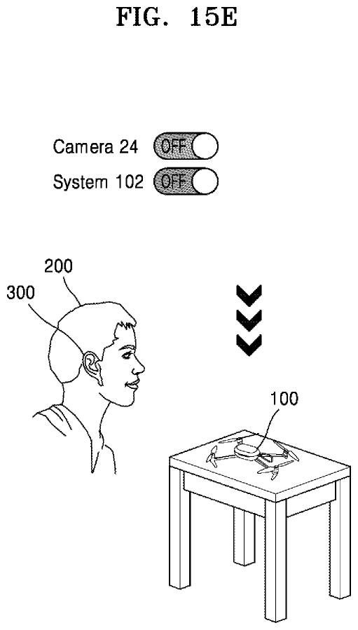

FIGS. 15A to 15E illustrate a plurality of example use cases, in accordance with one or more embodiments of the present disclosure. In one or more embodiments, the plurality of example use cases is discussed in the below paragraphs.

In a first example use case, the user 200 may be wearing the earbuds and listening to music. In this event, the user 200 may provide the voice command “take my selfie” via the earbud's microphone. After receiving the command, the system 102 may process the audio signals and transmits the signals to the earbud case 100 to trigger an event for initiating the camera 24 for clicking the selfie of the user 200.

In a second example use case, the user 200 may provide the voice command “take-off” via the earbud's microphone. In this event, the earbud case 100 may unfolds itself into the drone and takes off. The earbud case 100 may start hovering at a fixed distance from the user 200. Furthermore, the camera 24 may not be active and not aligned with the user 200.

In a third example use case, the system 102 (e.g., the vision-less tracking system (VTS)) may be activated while the camera 24 remains inactive. The VTS may estimate the relative positions of the left and the right earbud with respect to the earbud case 100. The accuracy of the system 102 may be further enhanced using the RSSI signals received from each of the left earbud and the right earbud. Furthermore, the earbud case 100 may automatically start adjusting its orientation in 3D space in order to align the camera 24 towards the user 200.

In a fourth example use case, the camera 24 may be activated, and the selfie of the user 200 may be captured and saved in the user's phone's gallery. Further, the camera 24 may be deactivated after capturing the selfie and the system 102 may remain active.

In a fifth example user case, the system 102 may be deactivated, to enable the earbud case 100 for auto landing, and the earbud case 100 may get fold.

In various embodiments, the present disclosure at least provides the following advantages:

The present disclosure uses the RSSI values for enhanced tracking of the position of the user 200, thereby eliminating the need for the installation of the one or more cameras 24. The present disclosure utilizes minimal energy for transmitting and receiving the signals.

Further, the present disclosure minimizes the computational load by avoiding complex image-processing tasks, thus conserving battery power for essential flight operations of the earbud case 100.

Furthermore, the present disclosure enables tracking in various lighting conditions such as both bright and dark environments Thus, enabling the tracking unaffected from the occlusions.

In addition, the present disclosure enables tracking dynamic and cluttered environments. The present disclosure provides enhanced privacy.

Moreover, the present disclosure enables tracking with low power consumption, thereby enabling the earbud case 100 to sustain longer flight times.

The present disclosure uses the ANC to filter out the rotor noise, thereby ensuring clean audio capture without interference from mechanical sounds.

The present disclosure may be adaptive to changing audio environments, switching between the user speech and important environmental sounds, without missing key moments.

The present disclosure provides the synchronized audio video that eliminates the need for post-processing, saving time and effort for content creators and delivering ready-to-publish content.

The present disclosure provides seamless synchronization of the captured merged audio and the captured video, thereby ensuring perfect alignment, even during audio stream switching, providing a smooth viewing experience for audiences.

The present disclosure may be designed for outdoor and indoor vlogging scenarios where the background noise and drone noise may disrupt content quality. The system 102 adjusts dynamically based on real-time audio inputs.

The embodiments disclosed herein can be implemented through at least one software program running on at least one hardware device and performing network management functions to control the elements. The elements can be at least one of a hardware device or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

What is claimed is:

1. A method for tracking a position of a user by an earbud case, the method comprising:
estimating position vectors in three-dimensional (3D) space for one or more earbuds being worn by the user and the earbud case based on sensor data received from one or more inertial measurement unit (IMU) sensors;
estimating a central virtual point corresponding to positions for the one or more earbuds and the earbud case based on the position vectors, wherein the central virtual point indicates a static point with reference to the estimated position vectors;
estimating relative position vectors of the one or more earbuds and the earbud case based on the central virtual point and received signal strength indicator (RSSI) values for signals received from the one or more earbuds;
determining a yaw value and a pitch value based on the relative position vectors; and
positioning the earbud case based on the yaw value and the pitch value such that the position of the user is tracked by the earbud case.

2. The method of claim 1, wherein the one or more earbuds and the earbud case comprise the one or more IMU sensors, and
wherein the sensor data comprises at least one of accelerometer data, gyroscope data, or magnetometer data.

3. The method of claim 1, further comprising:
determining the RSSI values based on filtering noise from the signals received from the one or more earbuds using an artificial intelligence (AI) model.

4. The method of claim 1, wherein the estimating the position vectors comprises:
determining a velocity of the one or more earbuds and the earbud case based on integrating acceleration data over time;
determining integrated position data of the one or more earbuds and the earbud case based on integrating the velocity of the one or more earbuds and the earbud case over time;
determining an orientation of the one or more earbuds and the earbud case based on integrating an angular velocity of the one or more earbuds and the earbud case obtained from gyroscope data;
modifying the orientation of the one or more earbuds based on magnetometer data corresponding to respective axes of the one or more earbuds and the earbud case; and
estimating the position vectors based on correlating the modified orientation with the integrated position data.

5. The method of claim 1, wherein the estimating the central virtual point comprises:
determining a centroid of the position vectors of the one or more earbuds and the earbud case based on the estimated position vectors; and
estimating the central virtual point based on the centroid.

6. The method of claim 1, wherein the estimating the relative position vectors comprises:
estimating initial relative position vectors corresponding to the one or more earbuds and the earbud case based on the estimated central virtual point;
modifying the initial relative position vectors based on the RSSI values for the signals received from the one or more earbuds; and
estimating the relative position vectors based on the modified initial relative position vectors.

7. The method of claim 6, wherein the modifying the initial relative position vectors of the one or more earbuds and the earbud case comprises:
estimating a distance between a centroid vector and an initial relative position vector of the earbud case based on the RSSI values, wherein the centroid vector indicates a mid-point of the one or more earbuds;
computing an error function based on the estimated distance, wherein the error function indicates a difference between the estimated distance and an actual distance obtained from the estimated position vectors;
modifying the initial relative position vectors based on minimizing the error function using optimizing techniques; and
estimating the relative position vectors based on the modified initial relative position vectors.

8. The method of claim 7, further comprising:
determining the centroid vector based on initial relative position vectors of the one or more earbuds; and
determining a directional centroid vector based on normalizing the centroid vector.

9. The method of claim 8, further comprising determining a modified centroid vector based on the relative position vectors.

10. The method of claim 1, further comprising:
receiving input from one or more cameras integrated with the earbud case in a flying state of the earbud case for capturing video,
wherein the input indicates at least one of image data or video data associated with the user.

11. The method of claim 1, further comprising:
capturing audio by at least performing, in real time, a predefined noise cancelation operation to minimize background noise from audio signals received from the one or more earbuds.

12. The method of claim 11, wherein the one or more earbuds comprise a first earbud and a second earbud, and
wherein the first earbud is worn by the user and the second earbud is retained in the earbud case.

13. The method of claim 12, further comprising:
determining one or more characteristics associated with the audio signals based on analyzing the audio signals, wherein the one or more characteristics comprises frequency, amplitude, and patterns associated with the audio signals;
detecting at least one of a user speech and an environmental sound based on the determined one or more characteristics, wherein the user speech is detected from audio signals corresponding to the first earbud and the environmental sound is detected from audio signals corresponding to the second earbud;
dynamic switching between the first earbud and the second earbud based on the at least one of the user speech or the environmental sound; and
merging a first audio stream associated with the first earbud and a second audio stream associated with the second earbud based on the dynamic switching to obtain the merged audio.

14. The method of claim 13, further comprising synchronizing the merged audio and the captured video using a latency correction model and a real-time signal processing model.

15. An earbud case for tracking a position of a user, the earbud case comprising:
at least one processor; and
memory storing at least one instruction,
wherein the at least one instruction, when executed by the at least one processor individually or collectively, causes the earbud case to:
estimate position vectors in three-dimensional (3D) space for one or more earbuds being worn by the user and the earbud case based on receiving sensor data from one or more inertial measurement unit (IMU) sensors;
estimate a central virtual point corresponding to positions for the one or more earbuds and the earbud case based on the position vectors, wherein the central virtual point indicates a static point with reference to the estimated position vectors;
estimate relative position vectors of the one or more earbuds and the earbud case based on the central virtual point and a received signal strength Indicator (RSSI) value for signals received from the one or more earbuds;
determine a yaw value and a pitch value based on the relative position vectors; and
position the earbud case based on the yaw value and the pitch value such that the position of the user is tracked by the earbud case.

16. The earbud case of claim 15, wherein the at least one instruction, when executed by the at least one processor individually or collectively, further causes the earbud case to:
determine the RSSI value based on filtering noise from the signals received from the one or more earbuds using an artificial intelligence (AI) model.

17. The earbud case of claim 15, wherein the at least one instruction, when executed by the at least one processor individually or collectively, further causes the earbud case to:
determine a velocity of the one or more earbuds and the earbud case based on integrating acceleration data over time;
determine integrated position data of the one or more earbuds and the earbud case based on integrating the velocity over time;
determine an orientation of the one or more earbuds and the earbud case based on integrating an angular velocity of the one or more earbuds and the earbud case obtained from gyroscope data;
modify the orientation based on magnetometer data corresponding to respective axes of the one or more earbuds and the earbud case; and
estimate the position vectors based on correlating the modified orientation with the integrated position data.

18. The earbud case of claim 15, wherein the at least one instruction, when executed by the at least one processor individually or collectively, further causes the earbud case to:
determine a centroid of the position vectors of the one or more earbuds and the earbud case based on the estimated position vectors; and
estimate the central virtual point based on the computed centroid.

19. The earbud case of claim 18, wherein the at least one instruction, when executed by the at least one processor individually or collectively, further causes the earbud case to:
estimate initial relative position vectors corresponding to the one or more earbuds and the earbud case based on the central virtual point;
modify the initial relative position vectors based on the RSSI value for the signals received from the one or more earbuds; and
estimate the relative position vectors based on the modified initial relative position vectors.

20. A non-transitory computer-readable storage medium having stored thereon instructions that, when executed by at least one processor of earbud case individually or collectively, cause the earbud case to:
estimate position vectors in three-dimensional (3D) space for one or more earbuds being worn by a user and a earbud case based on receiving sensor data from one or more inertial measurement unit (IMU) sensors;
estimate a central virtual point corresponding to positions for the one or more earbuds and the earbud case based on the position vectors, wherein the central virtual point indicates a static point with reference to the position vectors;
estimate relative position vectors of the one or more earbuds and the earbud case based on the central virtual point and a received signal strength indicator (RSSI) value for signals received from the one or more earbuds;
determine a yaw value and a pitch value based on the relative position vectors; and
position the earbud case based on the yaw value and the pitch value such that the position of the user is tracked by the earbud case.
